(19) United States
(12) Patent Application Publication
(10) Pub. No.: US 2010/0117461 A1
(43) Pub. Date: May 13, 2010

(54) ELECTROMOTIVE MACHINES

(75) Inventor: John Frederick Eastham, Bath (GB)

Correspondence Address: STOUT, UXA, BUYAN & MULLINS LLP, 4 VENTURE, SUITE 300, IRVINE, CA, 92618, US

(73) Assignee: Force Engineering Limited, Leics (GB)

(21) Appl. No.: 12/311,773

(22) PCT Filed: Oct. 10, 2007
(86) PCT No.: PCT/GB2007/003849

§ 371 Date: Jan. 12, 2010

(30) Foreign Application Priority Data
Oct. 10, 2006 (GB) 0620068.7

(51) Int. Cl. H02K 41/025; H02K 3/04

(52) U.S. Cl. 310/13; 310/210

(57) ABSTRACT

An electromotive machine (200) comprises a stator (210), comprising a plurality of primary windings (215; 500; 520; 540), and a rotor (220). The primary windings (215; 500; 520; 540) are concentrated windings. The rotor (220) comprises secondary windings (230; 300; 400).

### FIELD OF THE INVENTION

The present invention relates to the field of electromotive machines. More particularly the invention relates to electric motors and generators comprising a stator having concentrated primary windings.

### BACKGROUND ART

As is well known, when an electric motor is driven by an external means, so that the motor's rotor is moved sufficiently quickly relative to its stator, the motor will normally act as a generator of electricity. Equivalently, when sufficient current is supplied to a generator, its rotor will normally move relative to its stator, and the generator will act as a motor. In view of that interchangeability of function, the term “electromotive machine” is used for convenience herein, to refer interchangeably to motors and/or generators.

The most well-known construction of electromotive machine comprises a moveable rotor which rotates inside a fixed, substantially cylindrical stator. The term “rotor” is used herein to describe the part of the electromotive machine that is moved, by an electromagnetic field in a motor, or to induce current in a generator. In some electromotive machines, the rotor does not rotate but rather is, for example, translated linearly. The stator is the fixed part of the machine that generates the driving electromagnetic field in a motor, or in which current is induced in a generator. The stator usually comprises a long length of insulated conductor, wound repeatedly to form a “primary winding”. The winding is usually wound onto a ferrous core, for example a laminated steel core (although a ferrous core is not strictly necessary). A plurality of primary windings may be present in the stator.

The term “coil” is used to refer (i) to a conductor arranged in a slotted core, with a leading coil side in a first slot and a trailing coil side in a second slot, or (ii) in the context of a synchronous machine or dc machine, to a conductor arranged around a pole core. The terms “winding” and “windings” are used to refer to a set of coils; the term is often qualified: for example, “phase winding” means all of the coils connected to one phase.

Electromotive machines can be classified in a number of different ways. One way is by the shape of the stator: it may, for example, be planar (in a linear machine), a cylindrical tube or a disk. Linear machines are used in a wide variety of machines, for example in fairground rides, in baggage-handling machines, in urban transport (e.g. monorail) vehicles and in various other launch applications.

Another classification approach is by whether the stator is single or double, that is, whether there is a stator on one side of the rotor or on two opposite sides.

Another way of classifying a machine is by the form of its rotor (this is probably the most common approach to classification). There are essentially two broad classes of rotor: rotors comprising a permanent magnet and rotors comprising conductors. The former are found in synchronous electromotive machines and the later especially in induction electromotive machines. Wound rotors are also commonly found in synchronous machines: turbo-alternators and machines larger than a few kilowatts generally have wound rotors. The rotor (excitation) winding in a synchronous machine is supplied with D.C. current to produce the same sort of field (which is stationary with respect to the rotor) as a permanent magnet array.

Hybrid types of electromotive machines also exist, in which the rotor comprises both a permanent magnet and conductors. Conductors in a rotor themselves take various forms, for example a simple plate, a “squirrel cage” of interconnected bars, or insulated-conductor windings (known as secondary windings).

There are two main forms of (primary) windings in use in stators in small and medium-size machines. The first is double-layer windings, which are employed in induction motors and in some motors with permanent magnet excitation; those machines find use in general industrial applications. The second form of windings is concentrated windings, which are in general use only for motors with permanent magnet excitation; those machines are used for both general industrial applications and (notably) in computer hard-disk drives.

A coil 20 for a double layer winding is shown at FIG. 1. The coil 20 comprises an insulated, conductive wire, wound on a ferrous core 30. For ease of illustration, the stator 10 from a linear motor is shown. Ferrous core 30 includes a plurality of slots 40. The first or leading side 20a of the coil 20 occupies the top half of a slot 40a whilst the second side 20b is positioned in the bottom of a slot 40b one coil pitch away from the first side 20a. As successive coils 20 are positioned in the stator 10 in the manner of FIG. 2, the coils 20 at the ends of the stator 10 overlap, forming a quite bulky side region. FIG. 2 illustrates a stator for a four-pole linear motor; the difficulty of winding a linear machine is apparent: the winding has to terminate at each end and either half-filled slots 40c or coil sides 20c over the ends of the machine must be used (in FIG. 2 both techniques are illustrated, with two half empty slots 40c and two coils 20c outside the end of the machine; see FIG. 2(b)).

Coils 120 for a concentrated winding are shown in FIG. 3. The coil 120 again comprises an insulated, conductive wire, wound on a ferrous core 130. Ferrous core 130 includes a plurality of slots 140. The coils 120 are positioned in the slots 140 as shown in FIG. 4, which like FIG. 2 shows a four-pole linear motor. The concentrated windings 120 are each arranged adjacent to a neighbouring winding 120; in contrast with the double-wound case, adjacent coils do not overlap in the concentrated windings. Although other definitions are possible, a stator comprising concentrated windings is defined (as used herein) as a stator comprising a plurality of windings each arranged adjacent to, but not overlapping with, at least one other winding of the plurality.

The advantage of using this form of winding is immediately apparent. First, there is no coil overlap at the sides of the machine, leading to a larger active pole width for a given total machine width. Second, if open slots 140 are used, the coils 120 can be totally preformed and easily inserted in the slots 140, which leads to reduced labour costs. Finally, the winding produces no difficulties at the ends of the machine since all the slots 140 are filled and there are no coil sides around the ends; that latter point is particularly important when a long stator assembly (for, say, a launcher application) is needed, as stator modules that can be butted up to each other can be made.

FIG. 5 illustrates the slot current pattern for two pole pitches produced by a double layer winding (first the winding is shown and then the slot current patterns). The patterns are very approximately sinusoidal and are symmetrical about the zero line. From the symmetry it can be deduced algebraically that only odd harmonic fields can be present. Furthermore, if the slot currents from all the phases are added with the correct phase relationships, a travelling wave is produced. This can be seen qualitatively by drawing the total slot current at progressive times in the cycle, as shown in FIG. 5, where the field moves on by a ¼ of wavelength in space as time progresses by T/4 of a cycle. There are changes in the shape of the field between the two instants in time, which indicates that harmonic travelling fields are present.

A double-layer winding stator can be used with rotors comprising permanent magnets or conductors for induction. The largely sinusoidal nature of the magnetomotive force (mmf) driven by the slot currents is compatible with a good performance.

The behaviour of the concentrated winding is different and much larger harmonic fields are present. FIG. 6, which is drawn for the first two poles of the machine, illustrates the action. The slot current patterns produced are not symmetrical about the zero line, which means it can be deduced algebraically that both odd and even harmonics are present in the waveform. The travelling wave performance is again illustrated by showing patterns at two instants in time. The considerable change in shape between the two instants indicates that large travelling harmonic fields are present, and algebraic analysis confirms that, and shows that (amongst others) two large travelling fields are present. The first is the two-pole field that the winding is designed to produce and the second is a four-pole field travelling in the negative direction.

Analysis of the harmonics will now be described in more detail.

A single general machine winding which consists of a group of coils connected in series is equivalent to a set of windings, each consisting of a sinusoidal distribution of conductors, the distributions being harmonically related in space. The conductor distribution can then be expressed as a Fourier expansion with a zero average term. It can be assumed that the conditions in a machine are largely unaltered if the conductors and the slots are replaced by patches of infinitely thin conductors positioned on a plane iron surface. The patches of conductors are of the same width and placed in the same positions as the slot openings.

If a slot at θₛ contains Nₛ conductors and has a slot opening of 2δ then the conductor distribution produced by the slot is given by:

$${N}_{p} = \frac{1}{π} {\int }_{θ s - δ}^{θ s + δ} \frac{{N}_{s}}{2 δ} exp ( - j p {θ}_{s} ) d θ$$

$${N}_{p} = \frac{1}{π} \frac{sin p δ}{p δ} {N}_{s} exp ( - j p {θ}_{s} )$$

where p is an integer, the harmonic number.

The winding distribution for say the ‘a’ phase of the winding is then given by

$${N}_{pa} = \frac{1}{π} \frac{sin p δ}{p δ} {\sum }_{s = 1}^{s = S} {N}_{sa} exp ( - j p {θ}_{sa} )$$

Where there are Nₛₐ conductors from the ‘a’ phase in the general s th slot at θₛₐ.

An example concentrated winding is shown on FIG. 15. If each of the coils has N turns then the ‘a’ phase distribution is:

$${N}_{pa} = \frac{N}{π} \frac{sin p δ}{p δ} ( exp j0 - exp \frac{j 2 πp}{3} )$$

$${N}_{pa} = \frac{2 N}{π} \frac{sin p δ}{p δ} exp ( - jπ p / 3 ) exp ( j π / 2 ) sin π p / 3$$

This means that Nₚₐ is zero for p=3m where m is an integer.

The equivalent expressions for the other two phases ‘b’ and ‘c’ may be found by an origin shift hence if:

Nₚₐ=Nₚ

then:

N_{pb}=Nₚexp(−2πp/3)

and:

N_{pc}=Nₚexp(−4πp/3)

The phase conductor distributions may be resolved into equivalent space sequence sets where n_{f}, n_{b}, and n_{z} are the forward backward and zero components respectively.

### Then:

nf=Nₚ/3{exp(j0)+exp(−j2πp/3+j2π/3)+exp(−j4πp/3+j4π/3)}

and it follows that n_{f}=Nₚ for p=1, 4, 7 etc and is zero for all other p.

nb=Nₚ/3{exp(j0)+exp(−j2πp/3+j4π/3)+exp(−j4πp/3+j2π/3)}

and it follows that n_{b}=Nₚ for p=2, 5, 8 etc and is zero for all other p.

nz=Nₚ/3{exp(j0)+exp(−j2πp/3)+exp(−j4πp/3)}

the sum of the term in the brackets is zero unless p=3m where m is a positive integer. Therefore since it was deduced earlier that Nₚ is zero when p=3m the zero sequence winding distribution is zero for all values of p.

When a positive sequence set of windings is fed with a balanced set of 3 phase currents a positive going field is produced, conversely when a negative sequence set of windings is fed with a balanced set of 3 phase currents a negative going field is produced. It follows that positive going waves are produced at p=1, 4, 7 and negative going waves are produced when p=2, 5, 8

The relative amplitudes of the waves is given by the factor:

$$\frac{sin p δ}{p δ} sin π p / 3$$

The mark to space ratio of the slots and teeth is commonly 60:40, which means that

δ=0.8π/3

for the 3 slot configuration analysed. Taking this value the magnitudes of the waves relative to the wave at p=1 are tabulated in Table 1 below.

A two-pole machine uses 3 coils as shown at FIG. 15(b) and produces a forward-going 2 pole wave and a backward-going 4 pole wave. A four pole machine is given by repeating the 3 coils of the 2 pole machine as shown in FIG. 15(c) and therefore produces a 4 pole forward going wave and a backward going eight pole wave. That has the effect of multiplying p for the 2-pole case by 2, i.e. the (forwards-travelling) fundamental in the 4-pole case corresponds to the (backwards-travelling) second-harmonic in the 2-pole case, with the direction of travel reversed. Therefore the large waves are 4-poles travelling in the positive direction and 8-poles travelling in the negative direction. It will be understood that 2 L pole windings can be formed by repeating the 3 coils of FIG. 15 L times.

TABLE 1
relative magnitude of harmonic waves in the 2-pole
and 4-pole cases.

| | p | | | | | | | | |
|---|---|---|---|---|---|---|---|---|---|
| | 1 | 2 | 3 | 4 | 5 | 6 | 7 | 8 | 9 |
| Direction | F | B | | F | B | | F | B | |
| Pole | 2 | 4 | 6 | 8 | 10 | 12 | 14 | 16 | 18 |
| number | | | | | | | | | |
| (n): | | | | | | | | | |
| two pole | | | | | | | | | |
| winding | | | | | | | | | |
| Pole | 4 | 8 | 12 | 16 | 20 | 24 | 28 | 32 | 36 |
| number | | | | | | | | | |
| (n): | | | | | | | | | |
| four pole | | | | | | | | | |
| winding | | | | | | | | | |
| Relative | 1 | 0.669 | 0 | 0.07 | 0.233 | 0 | 0.078 | 0.0684 | 0 |
| Magnitude | | | | | | | | | |

As an illustration of the concentrated windings' action, FIG. 7 shows the addition of a two-pole positively going wave (dashed line) and a four-pole negatively going wave (dotted line). Two instants of time are shown t=0 at FIG. 7(a), and t=T/4 at 7(b). The total patterns (solid line) approximate in shape to the total slot currents in FIG. 6.

Concentrated windings have been found to be useful only for machines with permanent-magnet rotors, which can produce force only from a field that has the same pole number. That property enables the same concentrated winding to be used with different pole-number secondaries (i.e. rotors), for example, the winding of FIG. 4 could be used with a rotor having either four- or eight-pole permanent magnet arrays.

Attempts have been made to use concentrated windings in induction motors, but the results have been unsatisfactory. The conductors of an induction-motor rotor have been found to respond to and produce force from any harmonic of the stator field; consequently, a large negative force results from the backward going fields produced by concentrated windings, and that detracts from the wanted positive force.

An object of the invention is to provide an electromotive machine, having concentrated primary windings, in which problems associated with prior-art concentrated-primary-winding machines are ameliorated or eliminated.

### DISCLOSURE OF THE INVENTION

In a first aspect, the invention provides an electromotive machine comprising (i) a stator comprising a plurality of primary windings, and (ii) a rotor; wherein said primary windings are concentrated windings and characterised in that the rotor comprises secondary windings.

As discussed above, a prior-art rotor comprising a permanent magnet will discriminate against unwanted harmonic fields. A rotor having k poles where k is even will substantially discriminate against all other pole numbers in that torque will be produced only from the k pole stator field.

In the electromotive machine of the invention, a secondary winding is used instead of a permanent magnet. An array of secondary windings has a number of poles, just like an array of permanent magnets. The secondary windings thus, like the permanent magnet secondary, will discriminate against unwanted harmonic fields so that substantially only the pole number for which the secondary is wound will induce currents and produce torque.

The stator has concentrated windings, which produce a plurality of field harmonics, as discussed above. A rotor comprising a conductive plate or squirrel-cage would substantially respond to fields of all pole numbers. However, the secondary windings of the rotor of the invention respond substantially to only one harmonic, and so the electromotive machine substantially avoids incurring the penalties that accrue from the other backward going fields.

As set out above, although other definition are possible, in the present description, the term “concentrated windings” is used to refer to a plurality of windings each arranged adjacent to, but not overlapping with, at least one other winding. Such an arrangement of the windings may be referred to as “planar concentrated windings”. The primary windings of the present invention may be polyphase windings having a planar non-overlapping construction.

The stator may comprise a ferrous core. The stator's core may be steel, for example laminated steel. The stator's core may define a plurality of slots. The concentrated windings may be seated in the slots. The slots may be open. The concentrated windings may be prefabricated. Prefabrication offers advantages including reduced production costs. Use of open slots is particularly convenient when using prefabricated windings, as the prefabricated windings may be placed directly in the slots.

The stator may be linear. The stator may be significantly longer than the rotor; for example, the stator may be more than twice, more than three times, or even more than ten times as long as the rotor.

The stator may be cylindrical. The stator may be disk-shaped.

The rotor may comprise a ferrous core. The rotor's core may be steel, for example laminated steel. The rotor's core may define a plurality of slots. The secondary windings may be seated in the slots. The slots may be open. The secondary windings of the rotor may be plural windings, that is a plurality of windings each arranged adjacent to, and overlapping with, at least one other winding of the plurality. The secondary windings of the rotor may be inductively energised polyphase windings.

The rotor may be arranged to produce torque on any pole number n that is even; n may for example equal 2, 4, 8, 10, 12, 14 or 16. There may be m windings, where m<n; that may be achieved by ensuring that each winding consists of an appropriate number of turns to provide a phase shift such that the phase shift along the length of the rotor is that of a wave having a wavelength (measured in slot pitches) different from the wavelength of the stator (again measured in slot pitches). The number of windings may be selected to provide a phase sequence that passes through 360 degrees over a number of slot pitches that is not equal to the number of slot pitches required for a transition of 360 degrees on the stator. Thus the rotor may provide the same number of poles as the stator over the same distance but over a different number of slots.

The rotor may be a wound plate. The windings may form a plurality of layers, preferably two layers. The windings may comprise a plurality of insulated, conductive strips, which may be brazed together at their ends to form the wound plate. The windings may comprise one or more insulated, conductive strips, which are folded to form the wound plate. The strips may form two sets, each of a plurality of conductive strips, the strips in the first set having a right-handed orientation and the strips in the second set a left-hand orientation, such that, when strips from the first and second sets are connected alternately together they form a zig-zag pattern. A plurality of the connected strips may be nested against each other to form the plate. The windings may form a plurality of layers, preferably two layers. The strips of the first set (the “zigs”) may form the upper layer of the wound plate and the strips of the second set (the “zags”) the lower layer.

At least some of the concentrated windings of the primary windings may be arranged as concentric coils. In one embodiment all of the concentrated windings are arranged as concentric coils. The said concentric coils may consist of two or more concentric coils. In one form of the invention, the outermost coils of the concentric coils of adjacent concentrated windings are located in a single slot of the rotor core. In an alternative form of the invention, the outermost coils of the concentric coils of adjacent concentrated windings are physically separated, for example by a divider, such as a tooth, provided in the slot of the rotor core.

The machine may be arranged to utilise power transferred in use from the primary to the secondary to power auxiliary mechanisms associated with the machine. For example, the transferred power may be utilised to run sources heat or light, for example in a traction vehicle in which the machine is comprised.

### BRIEF DESCRIPTION OF THE DRAWINGS

Certain illustrative embodiments of the invention will now be described in detail, by way of example only, with reference to the accompanying schematic drawings, in which:

FIG. 1 is a portion of a stator for a double-layer winding, showing a coil, in (a) plan view and (b) side view;

FIG. 2 is (a) a plan view of the arrangement of coils in the stator of FIG. 1, and (b) a part longitudinal cross-sectional view of stator;

FIG. 3 is a portion of a stator for a concentrated winding, showing a coil, in (a) plan view and (b) side view;

FIG. 4 is a four-pole linear machine using a concentrated winding, in (a) longitudinal cross-sectional view, and (b) plan view;

FIG. 5 is the slot current distribution at two time instants for a double-layer winding;

FIG. 6 is the slot current distribution at two time instants for a concentrated winding;

FIG. 7 is a plot showing forward-going two-pole and backward-going 4-pole waves (a) at arbitrary time zero and (b) a quarter of a second later;

FIG. 8 is (a) a machine according to an example embodiment of the invention with a concentrated stator winding and a short double-layer wound secondary, (b) detail of a rotor suitable for the machine of (a), with a simple, single-loop construction, and (c) plots of 2- to 10-pole waves for the rotor of (b);

FIG. 9 is a plot showing modelling results for four stator/rotor combinations;

FIG. 10 is a winding plan for a four-pole four-layer winding in 23 slots;

FIG. 11 is an illustration of a conductor shape for a wound plate secondary, in plan and cross-section;

FIG. 12 is a wound plate assembly;

FIG. 13 is an illustration of a folded conductor shape;

FIG. 14 is an illustration of how cylinder, linear and disk machines can be transformed into each other;

FIG. 15 shows (a) the phase behaviour of a concentrated winding, (b) a two-pole machine, using 3 coils and producing a forward-going 2-pole wave and a backward-going 4-pole wave, and (c) a 4-pole machine given by repeating the 3 coils of the 2 pole machine, which produces a 4-pole forward-going wave and an 8-pole backward-going wave.

FIG. 16 shows an example of a cylindrical electromotive machine according to an example embodiment of the invention, with a wound plate rotor.

FIG. 17 is an example of a stator for use in a machine that is an example embodiment of the present invention.

FIG. 18 shows a portion of a stator comprising concentrated windings in (a) side view and (b) plan view.

FIG. 19 shows a portion of a stator comprising concentrated windings in (a) side view and (b) plan view.

FIG. 20 is a plan view of a 4-pole winding using the arrangement of FIG. 18.

FIG. 21 is a plan view of a 4-pole winding using the arrangement of FIG. 19.

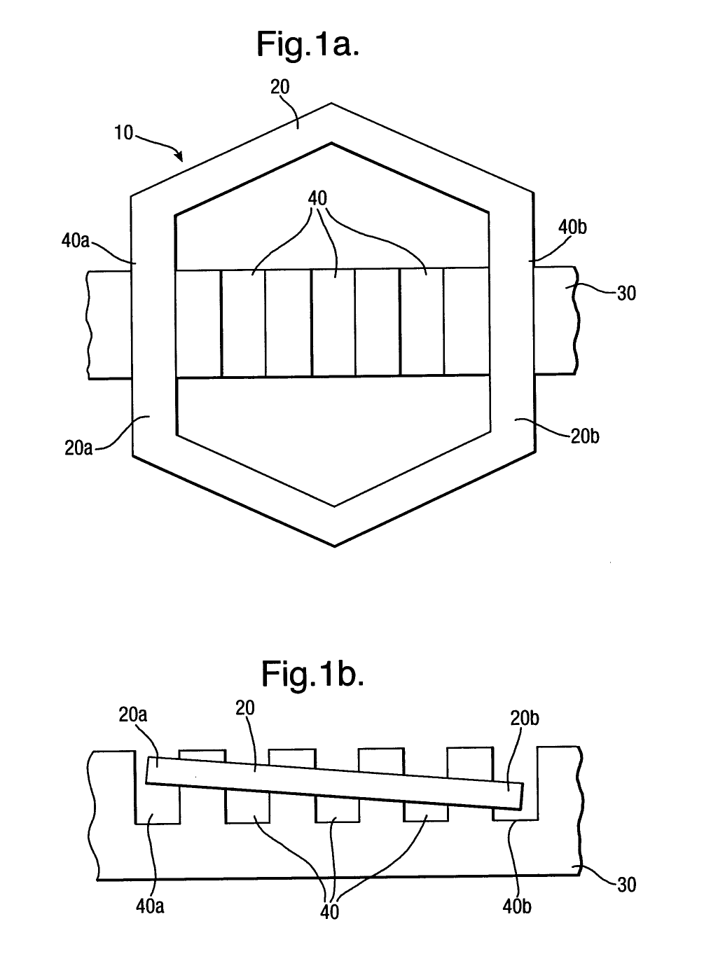

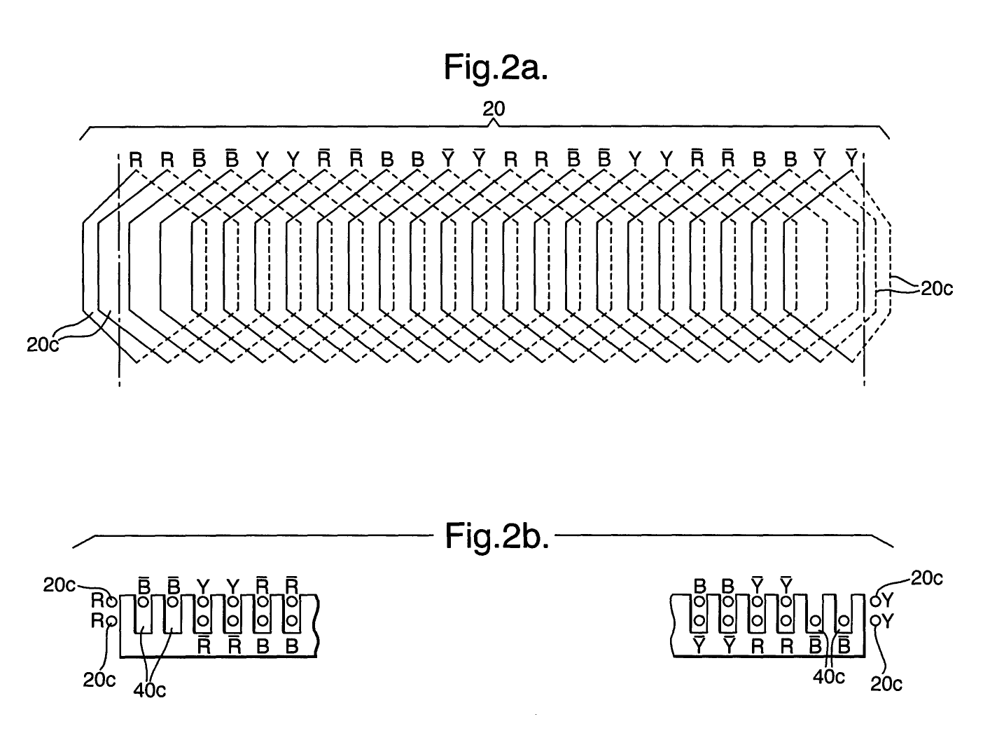

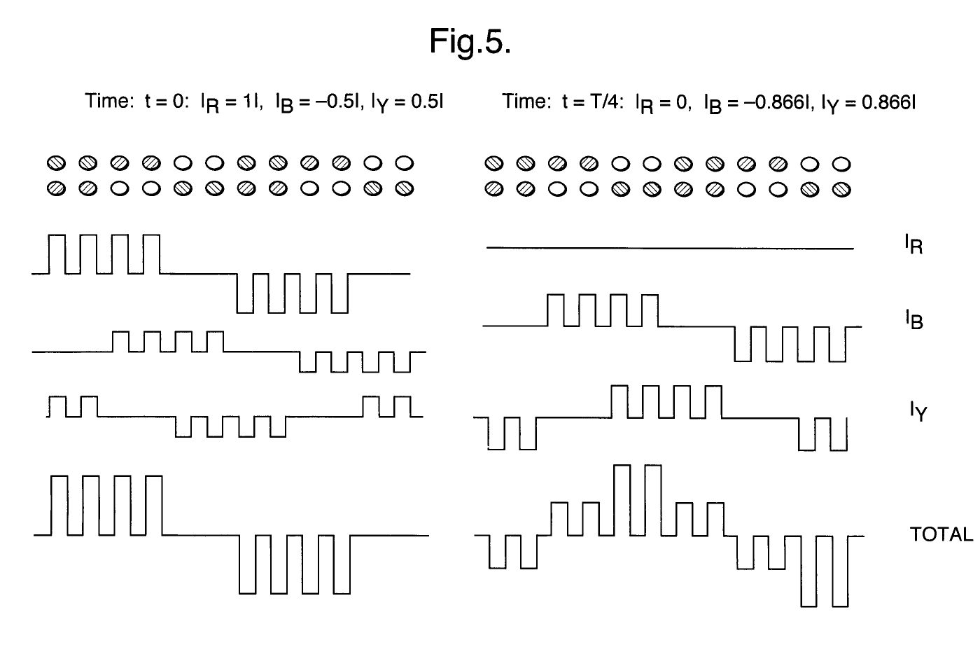

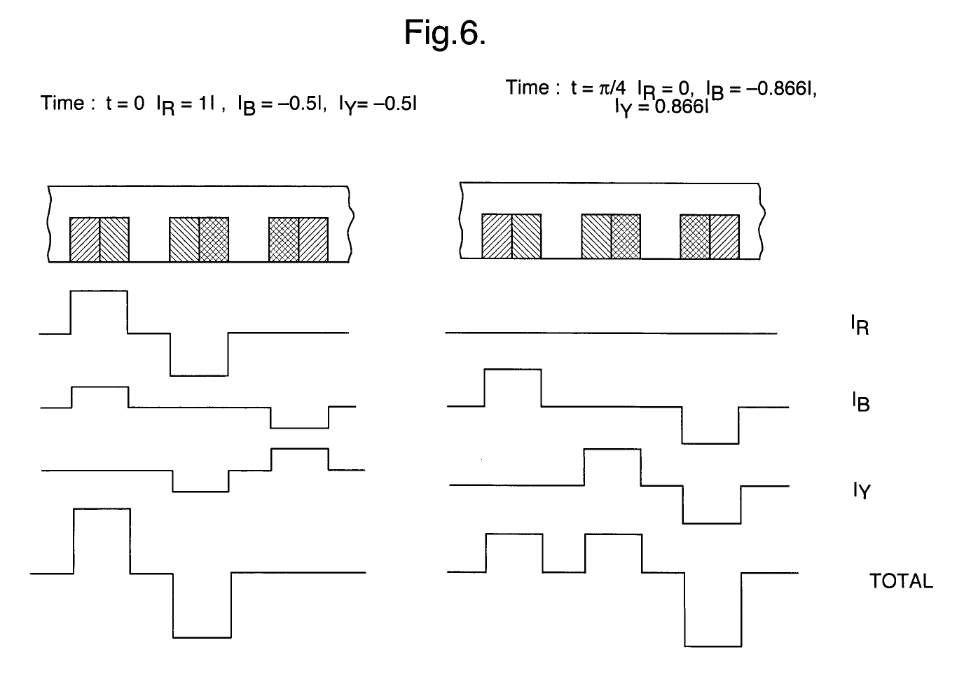

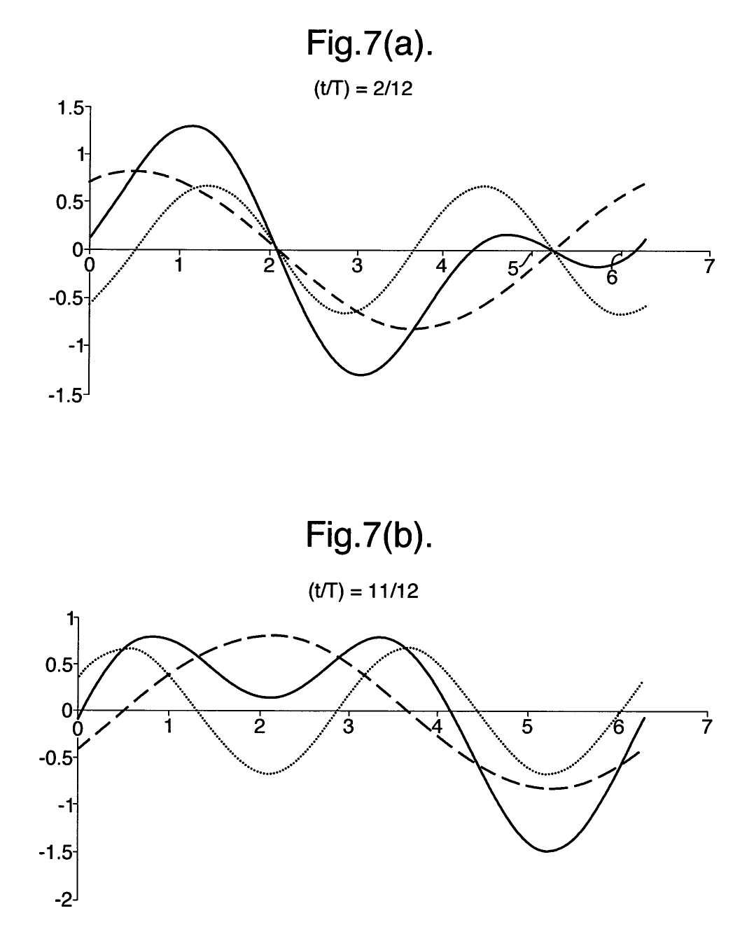

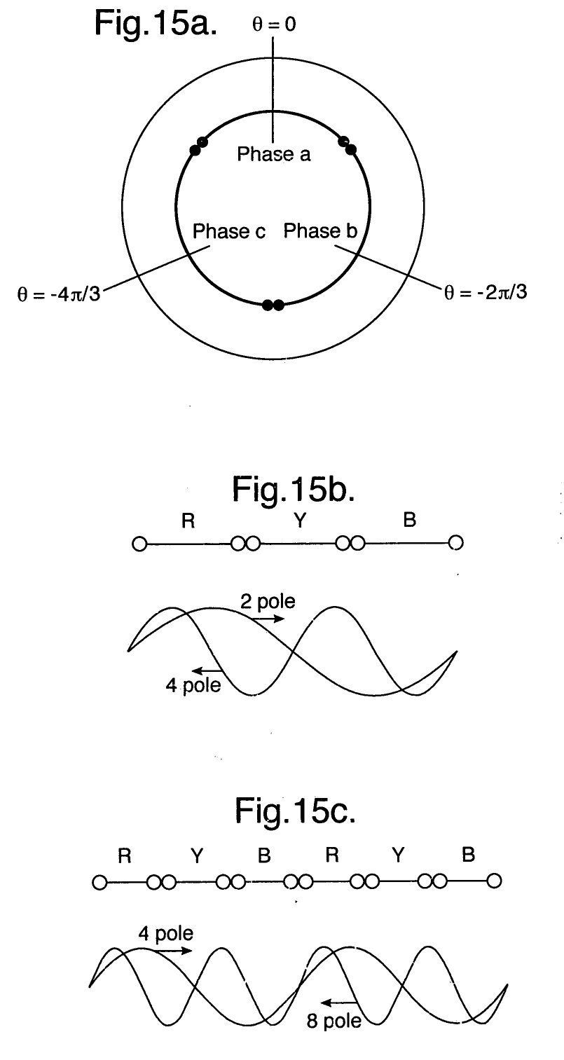

FIGS. 1 to 7 and 15 are discussed above.

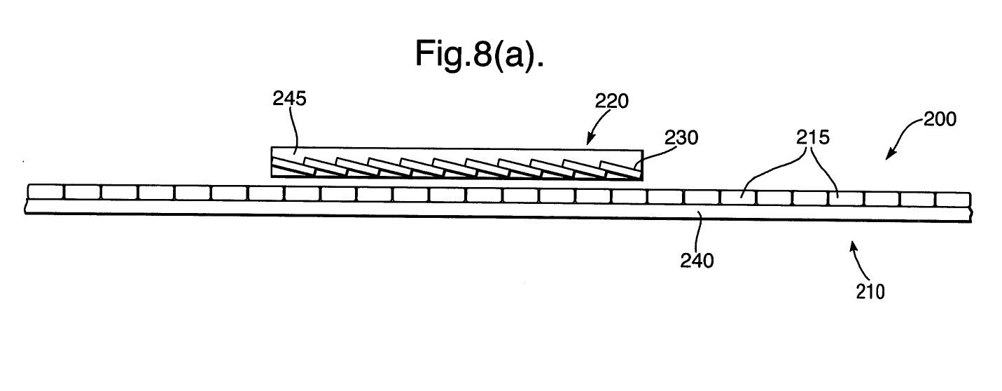

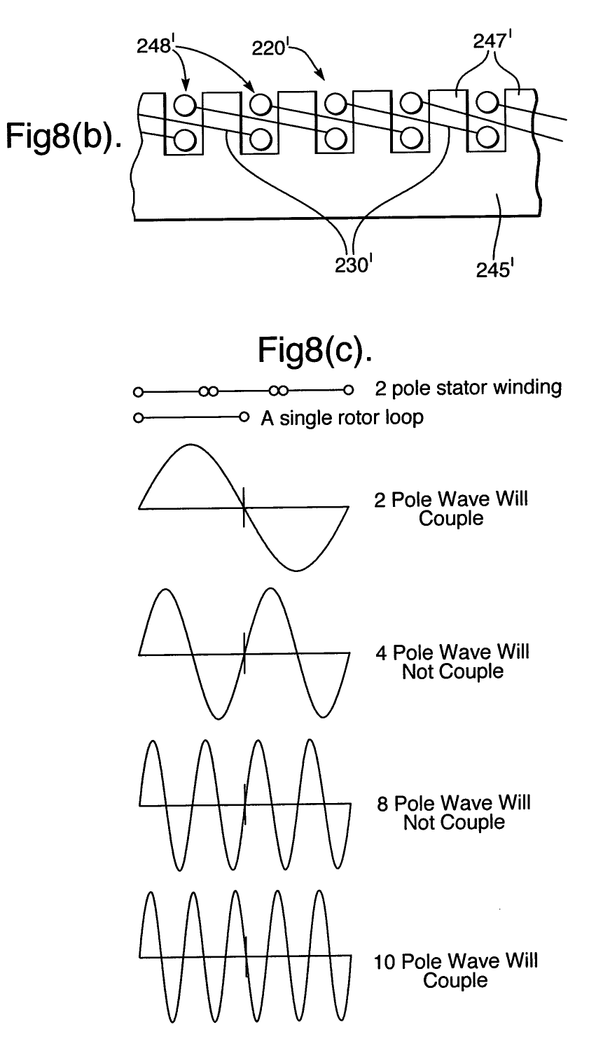

FIG. 8 shows an example of an electromotive machine 200 according to an embodiment of the invention. The machine 200 is a linear machine, comprising an elongate stator 210 and a short rotor 220; in use, rotor 220 is displaced linearly along stator 210. The machine 200 comprises a single-sided arrangement, in which the stator comprises concentrated windings 215, comprising insulated conductive wire wound on a ferrous core 240, and the rotor 220 is a secondary, comprising a slotted ferrous core 245 that carries a plurality of coils 230 (again insulated conductive wire wound on the core 245) in a double-layer winding. The winding 230 is short-circuited so that currents can be induced in it by the long stator 210.

FIG. 8(b) shows a rotor 220′ including a simple rotor winding, in the form of a ferrous core 245′ carrying a plurality of single independent loops 230′. Each loop 230′ sits in and extends from a slot 248′ across another slot to the next-neighbouring slot; thus each loop 230′ is wrapped around two adjacent columns 247′ of the core.

FIG. 8(b) shows how the 4 and 8 pole harmonics from the 2-pole concentrated windings 215 of the stator 210 do not couple with the loops 230′ (as the net stator field is zero over the length of each loop 230′); the first in the harmonic series to couple to the loops is the 10-pole component, which will generally be very weak compared with the 2-pole field.

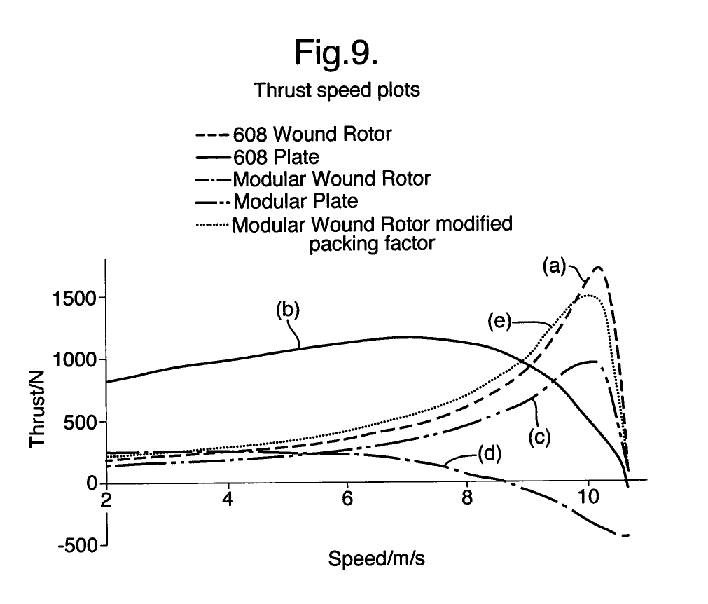

A beneficial effect of the invention can be seen from FIG. 9, which compares the forces produced by various arrangements of short rotor machines. Curve (b) sets a benchmark: it shows the force produced by a standard stator with a double-layer winding and plate rotor. Curve (a) is again for a double-layer stator and shows that a considerable improvement can be produced by a wound rotor; that is because the machine, unlike a plate rotor, has no end effects. Curve (c) shows the results for a wound rotor with a concentrated winding. Even though the results have not taken advantage of the extra winding space that can be adduced for the concentrated winding, they still compare favourably with curve (a): curve (c) shows force at much higher speeds, which indicates enhanced efficiency and power factor with a fraction of the rotor heating. Curve (d) shows the results for a plate rotor with a concentrated winding and it can be seen that, as expected, the large negative-going fields have considerably reduced the force. The measure of improvement brought about by the wound rotor when it is used with the concentrated winding is from curve (d) to curve (c). Further improvement is seen when advantage is taken of the enhanced winding space (curve (e)). Use of a wound rotor also makes it possible to take advantage of the reduced production costs of the concentrated winding machine.

It is clear from FIG. 9 that the force produced by a motor (and hence the current induced in a generator) varies with the operating speed. In practice, the machine is used in conjunction with an inverter, which is arranged to ensure that the operating speed is kept substantially at the speed that gives peak force; i.e. the speed corresponding to the peak of the relevant curve in FIG. 9.

The force produced by an electromotive machine is proportional to the winding area of the stator. The winding area is defined as the area of the core slots filled with copper divided by the slot area. A double-wound stator typically has a winding area of 0.4 to 0.5; a concentrated-wound stator typically has a winding area of about 0.7. Concentrated windings permit, for example by permitting utilisation of the space typically wasted at the ends of a double winding, an improvement of approximately 40% in the force produced; alternatively, a given force from double-windings can be produced from a reduced number of concentrated windings, which means for a reduced cost.

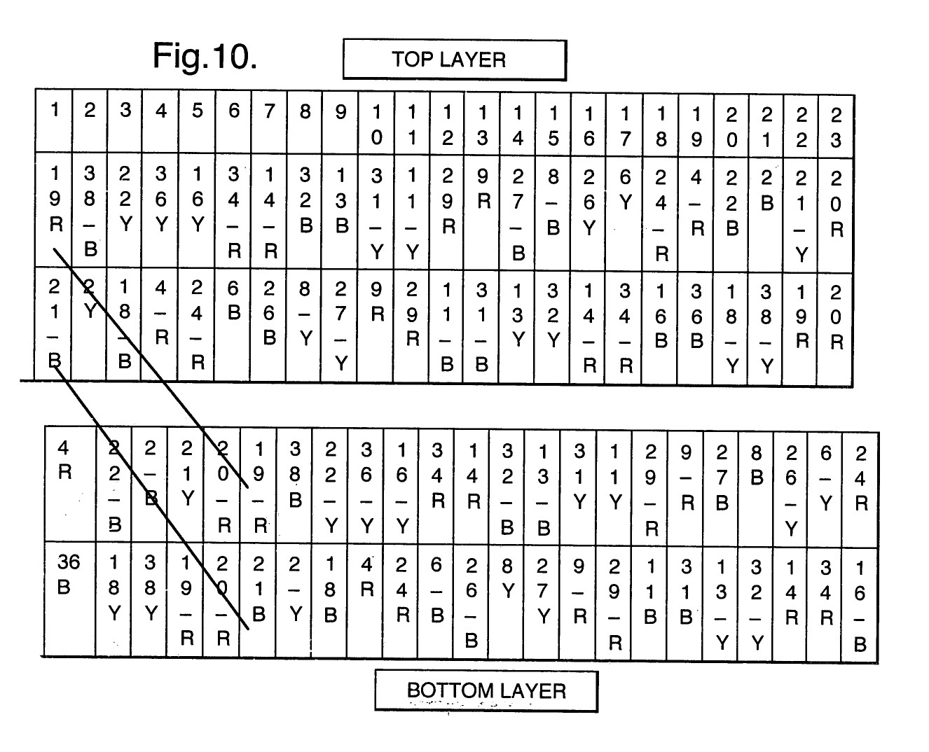

Secondary windings with a whole number of slots per pole and phase can produce magnetic locking with the stator and to deal with this situation, a special winding has been devised that produces 4 poles in 23 slots rather than 24. It uses 4 layers rather than two and was used for the modelling work of FIG. 8. It is shown in detail in FIG. 10. The numbers given in FIG. 10 correspond to the numbers of windings in each slot. Usually, in double-sided systems, a plate secondary is sandwiched between two stators. Use of a secondary winding enables the two stators to take the advantage of using concentrated primary (stator) windings; that is again because the winding will produce force substantially only from the pole number for which it is wound. S. Yamamura describes, in Section 14.2 of a “Theory of linear induction motors”, University of Tokyo Press, 1972, UTP 3065-67632-5149, a wound secondary having a plate-like form; the reference identifies the wound plate as being useful for its improved end-effects. Wound plates of that kind may also be used in a rotor of a machine according to the present invention.

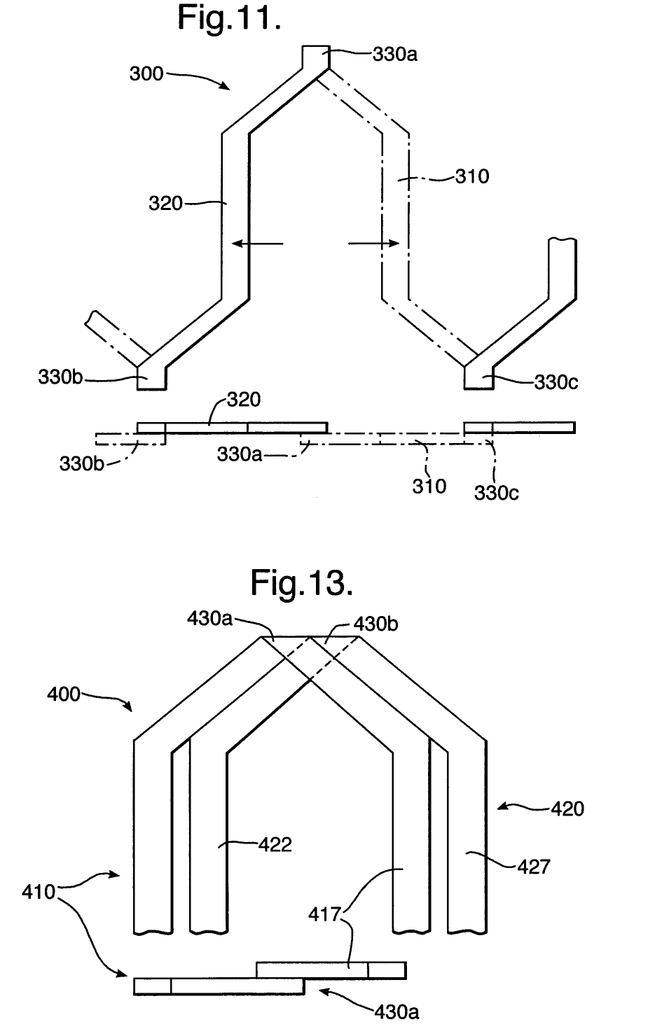

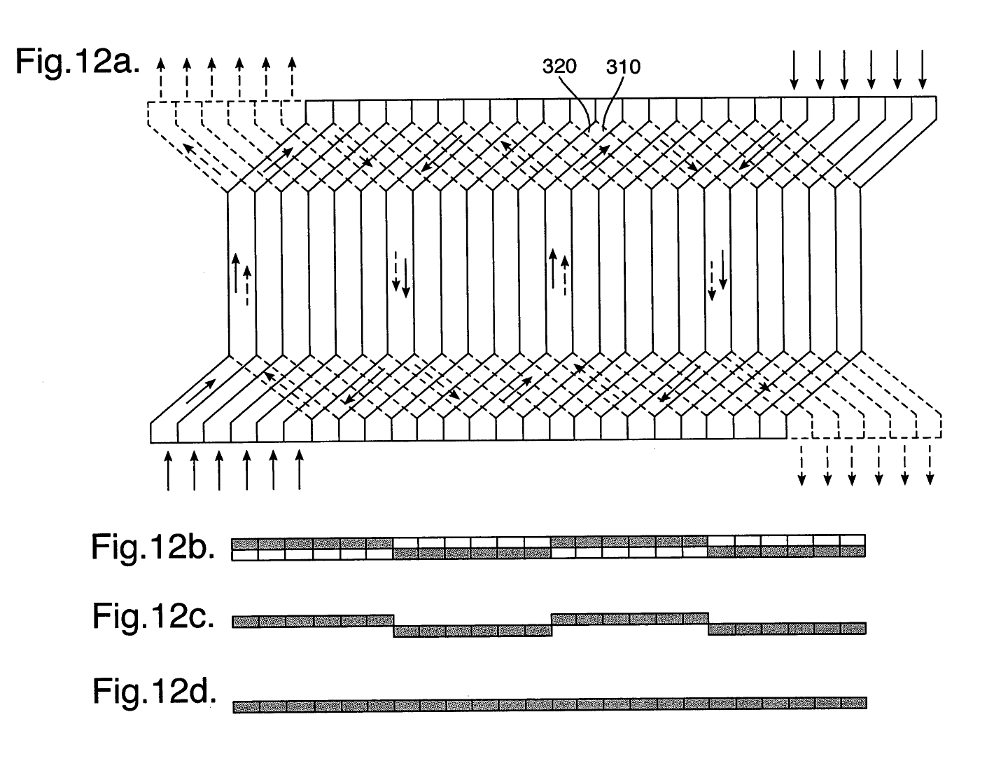

FIG. 11 illustrates a part 300 of such an arrangement. Insulated conductors 310, 320 are strip-like, elongate plates, having a substantially rectangular cross-section. Insulated conductor 310 (shown with dotted lines) is on the bottom layer whilst the second insulated conductor 320 (solid lines) takes the top layer. The ends 330a, b, of the conductors 310, 320 are connected together by brazing or other suitable means. Sets of these conductors 310, 320 are positioned together as shown in FIG. 12 forming (in this example) a 12-phase double-layer winding. This can be understood by following the sample phases shown with plain and dotted arrows. Star points (not shown) are made at the ends of the machine to yield a shorted secondary winding. Alternatively the dark-phase windings only can be used yielding a six phase system as shown in FIG. 12(c). Finally, the arrangement of (c) can be compressed into a single layer in the middle section as shown at FIG. 12(d).

The brazed conductor system described above (and that in Yamamura) can be replaced by a folded conductor system. A part 400 of this is shown in FIG. 13. Here first insulated strip conductor 410 is folded at fold 430a. Similarly, second insulated strip conductor 420 is folded at fold 430b. The two folds 430a and 430b are placed adjacent to each other, so that leading leg 417 of first conductor 410 crosses over trailing leg 422, and lies adjacent to leading leg 427, of second conductor 420. Addition of further strip conductors, overlaid in the same manner, forms the complete wound plate, which is short-circuited as with the brazed plate of FIG. 12.

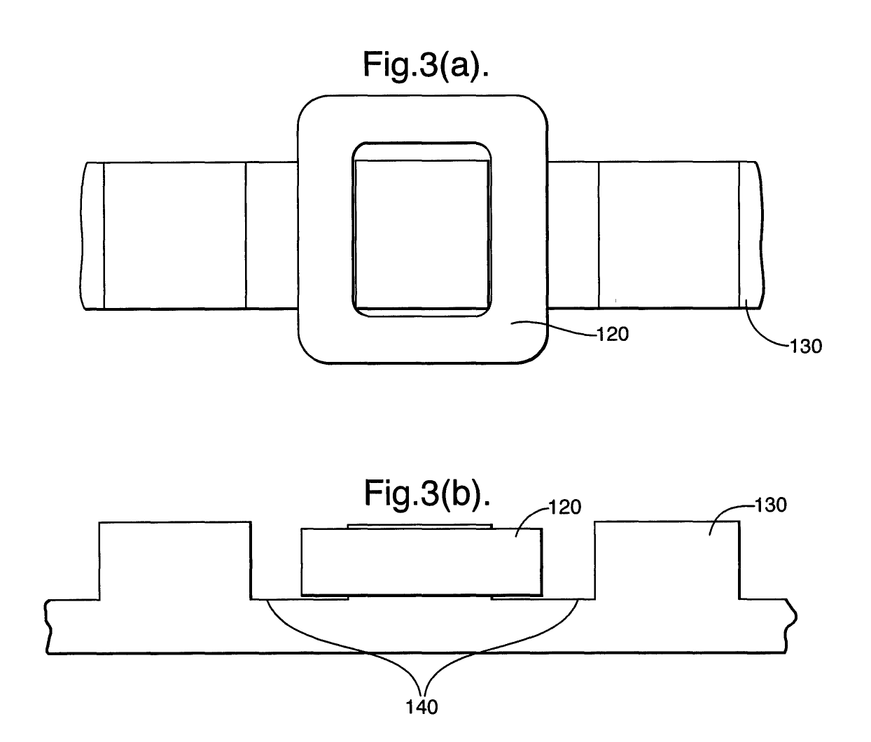

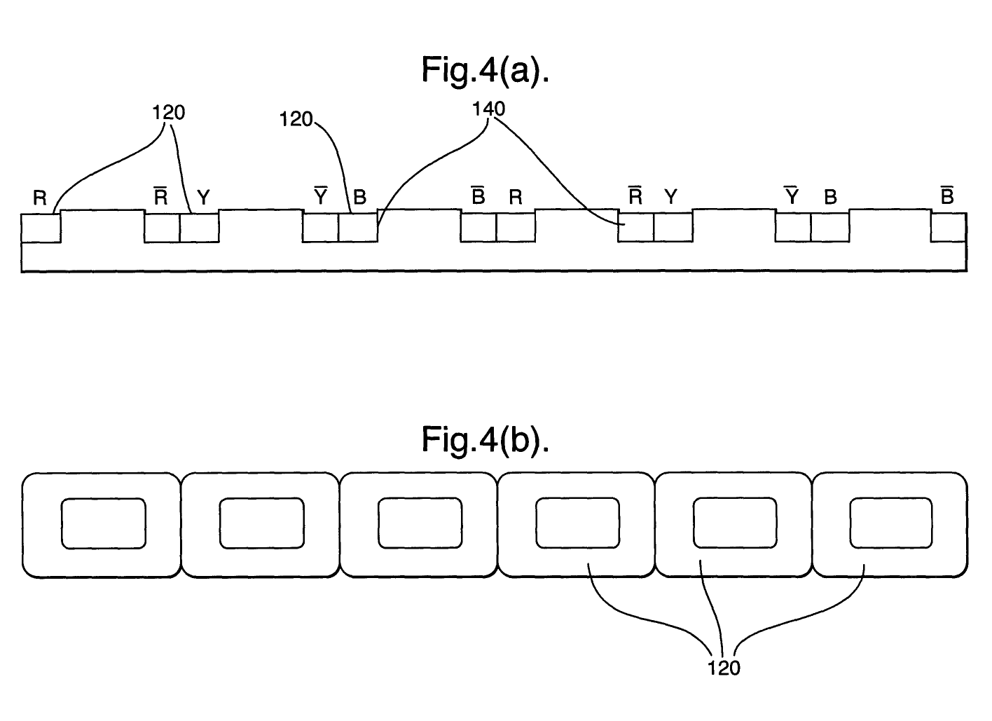

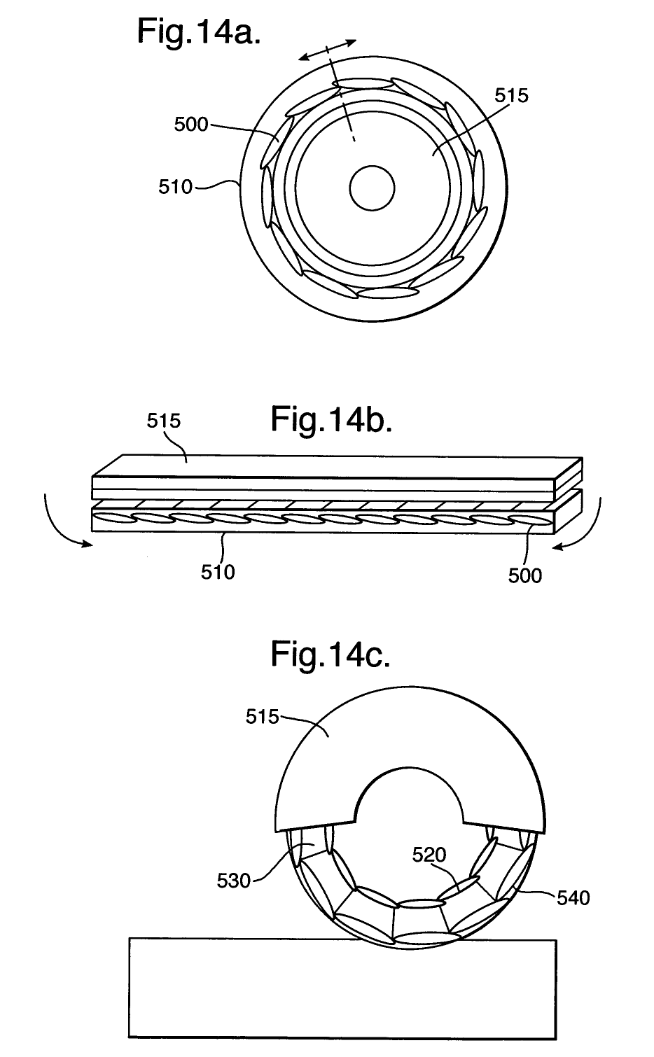

Cylindrical, disc and linear versions of a given electromotive machine can be formed by topological changes, as illustrated in FIG. 14. FIG. 14(b) shows a stator for a linear machine, including a layer 500 of concentrated windings and a ferrous-core layer 510. The linear machine has a plate rotor 515. FIG. 14 is highly schematic; of course, in practice, the ferrous core will extend into the layer of concentrated windings, which each encircle a portion of the core, as shown in, for example, FIGS. 3 and 4.

FIG. 14(a) shows how the linear machine can be topologically wrapped into a circle to form a related cylindrical machine. The rotor 515 is cylindrical and sits within the stator cylinder, perpendicular to the plane of FIG. 14(b). Concentrated windings 500 form an inner layer of the cylinder; ferrous core 510 forms an outer layer. This cylindrical machine may find duty as a high torque drag-cup servo machine.

FIG. 14(c) shows a machine having a double-sided stator disc. The rotor 515 has the shape of an annular disk and lies in a plane parallel to that of FIG. 14(c). Concentrated winding layers 520 and 540 form, respectively, an outer ring and an inner ring of an annular disc. Ferrous core 530 forms a ring intermediate between inner ring 520 and outer ring 540. This disc machine is being considered for duty as an induction generator.

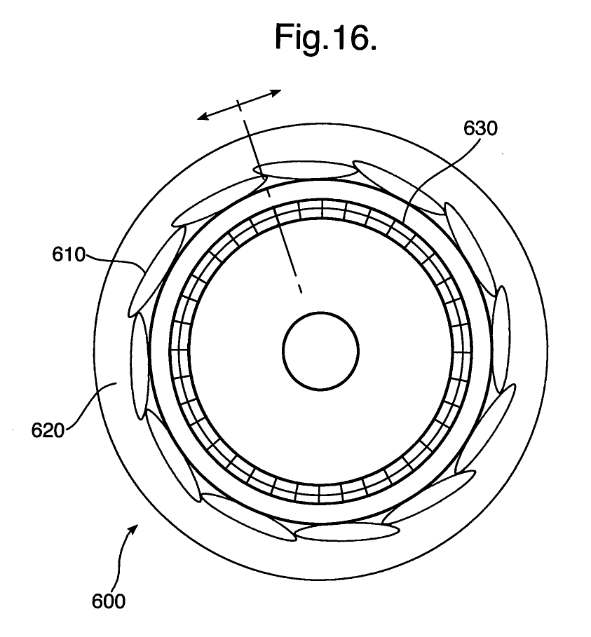

FIG. 16 shows another example of a cylindrical machine 600. Concentrated coils 610 are arranged in a tubular, ferrous core 620. Within core 620, wound rotor 630 is provided.

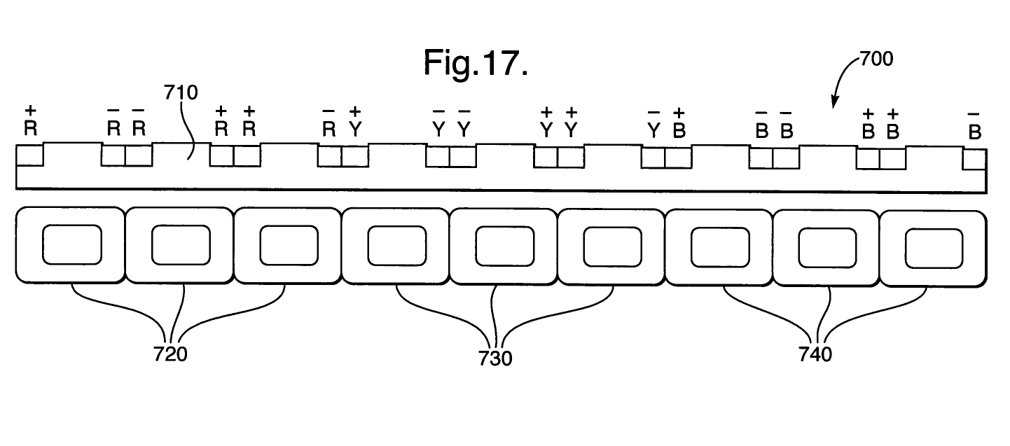

Many different arrangements of concentrated winding are possible. For example, FIG. 17 shows a stator 700 comprising a slotted stator 710 and three sets of three concentrated windings 710, 720, 730. Each set is connected to a different phase of a three-phase supply. Each coil portion that shares a slot with a portion of another coil having the same phase has current flowing in the same direction as the current in the other coil; each coil portion that shares a slot with a portion of another coil having a different phase has current flowing in the opposite direction as the current in the other coil. This 9-slot (coil) array has equal conductor distributions at both 8 and 10 poles and may be used for either according to the rotor pole number; thus the rotor may be designed to have either 8 or 10 poles, as desired.

The quality of the linear machines described above has been assessed by both finite element based modelling and practical tests. The broad conclusions that have been reached are:
The force produced by the machines is equal to that produced by conventional machines.
The input volt-amperes (VA) are greater than in conventional machines

The increase in input VA can be a disadvantage since it directly affects the size and cost of the power supply required. In machines that are inverter fed this can be quite crucial since that cost of the inverter is usually greater than that of the machine. In machines that are mains fed the impact is less but the higher cable costs involved can be important.

The increased input VA requirement is due to two factors:
An increase in magnetising current due to a reduced magnetising reactance.
An increase in the stator winding end turn leakage reactance.

The leakage reactance increase is due to the reduced number of coils in a phase winding. This can be argued in a simplistic way by taking a two pole machines as an example. In a two pole machine the conventional machine would generally have two coils per phase group and a total of four coils per phase. In comparison the winding using planar concentrated coils would have only one coil per phase. It follows that the coil in the planar concentrated coil winding would have about four times the turn number (to get the same induced emf) and of the order of 16 times the reactance of a coil in the conventional winding. Then using the number of coils in each case it is apparent that the end winding reactance will be four times in the planar concentrated winding case.

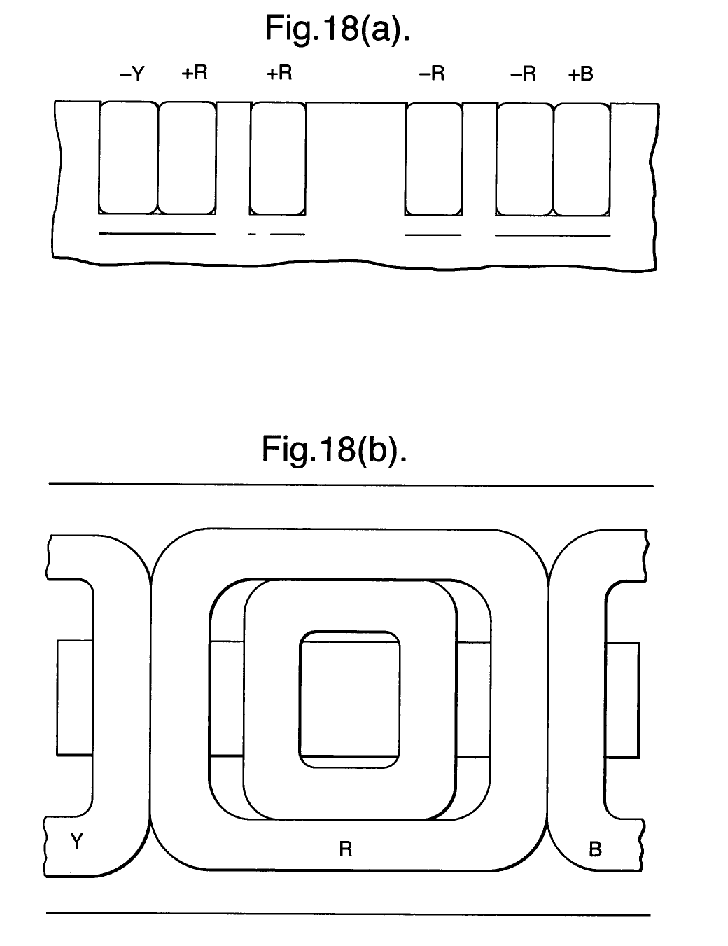

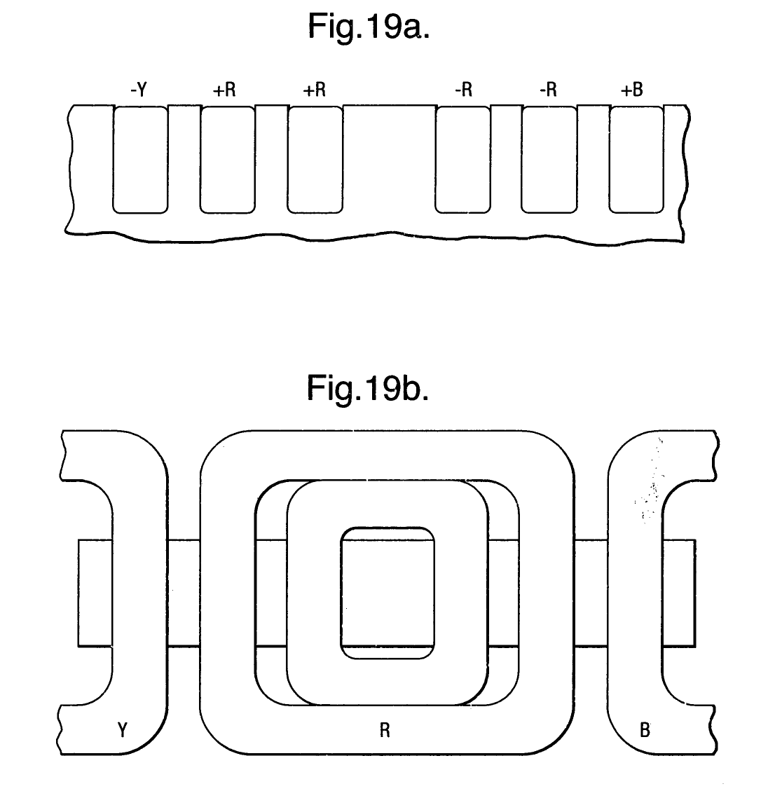

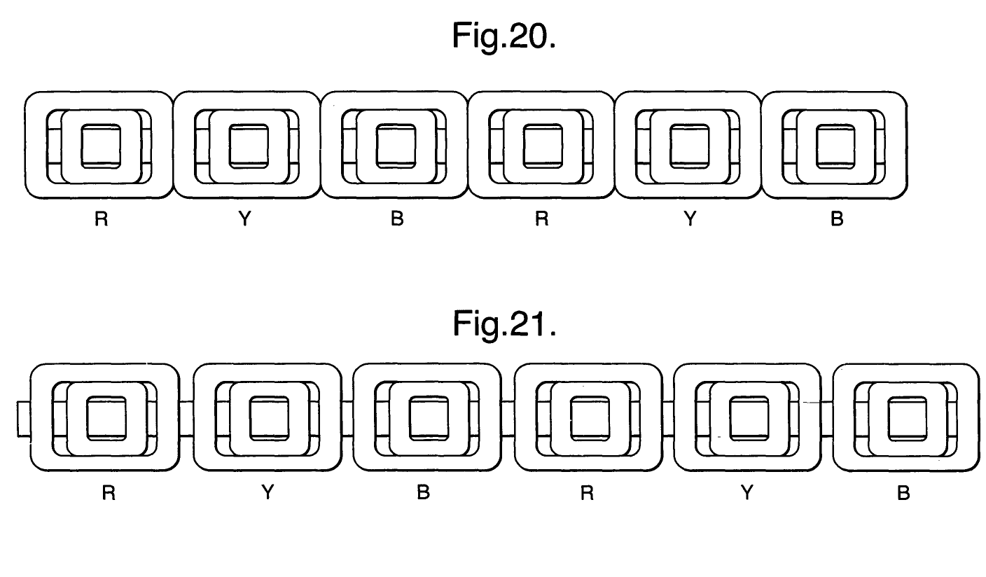

The increase in magnetising current is due to the increase in effective magnetic gap in the planar concentrated winding case. This is due to the increase in the size of the slot openings. Taking again the comparison above the total number of slots is 3 for the planar concentrated case and 12 for the conventional. If the pole-pitch is the same it follows that the slot openings will be of the order of 4 times greater in the planar concentrated case. This leads to increased perturbation of the air gap flux by the slots and a greater mmf drop across the gap so that the magnetic gap is increased. The VA input to all the machines described above can be reduced by substituting a planar group of concentric coils for each of the planar concentrated coils. This effectively subdivides the concentrated coils. The groups are further characterised by not overlapping adjacent groups and being connected in a R Y B sequence. FIG. 18 shows a drawing of a group with two concentric coils in which the outermost coil sides from adjacent groups occupy the same slot. FIG. 19 shows a similar arrangement that has a tooth between the outermost coil sides from adjacent groups. FIGS. 20 and 21 show the assembly of groups required for a 4-pole winding using the arrangement of FIGS. 18 and 19 respectively. Whilst the above examples are drawn for two coils in a concentric group it will be understood that any number of coils in a group is possible. The same technique can of course be applied to any of the modular windings for example the planar concentrated coils of the arrangement described above with reference to FIG. 17.

Whilst the present invention has been described and illustrated with reference to particular embodiments, it will be appreciated by those of ordinary skill in the art that the invention lends itself to many different variations not specifically illustrated herein. For that reason, reference should be made to the claims for determining the true scope of the present invention.

1. An electromotive machine comprising (i) a stator comprising a plurality of primary windings, and (ii) a rotor; wherein said primary windings are concentrated windings and characterised in that the rotor comprises secondary windings.

2. A machine as claimed in claim 1, in which the rotor comprises a core.

3. A machine as claimed in claim 2, in which the core defines a plurality of open slots, in which the secondary windings are seated.

4. A machine as claimed in claim 1, wherein said secondary windings of the rotor are inductively energised polyphase windings.

5. A machine as claimed in claim 1, in which the secondary windings of the rotor are plural windings.

6. A machine as claimed in claim 1, in which the rotor is arranged to produce torque on an even pole number n and there are m secondary windings, where m<n.

7. A machine as claimed in claim 6, in which the rotor provides the same number of poles as the stator but over a different wavelength.

8. A machine as claimed in claim 1, in which the rotor is a wound plate.

9. A machine as claimed in claim 8, in which the secondary windings comprise a plurality of insulated, conductive strips.

10. A machine as claimed in claim 9, in which the strips are brazed together at their ends to form the wound plate.

11. A machine as claimed in claim 9, in which the secondary windings comprise one or more insulated, conductive strips, which are folded to form the wound plate.

12. A machine as claimed in claim 9, in which the strips form two sets, each of a plurality of conductive strips, the strips in the first set having a right-handed orientation and the strips in the second set a left-hand orientation, such that, when strips from the first and second sets are connected alternately together they form a zig-zag pattern.

13. A machine as claimed in claim 9, in which a plurality of the connected strips are nested against each other to form the plate.

14. A machine as claimed in claim 1, wherein at least some of said concentrated windings of said primary windings are arranged as concentric coils.

15. A machine as claimed in claim 14, wherein the outermost coils of the concentric coils of adjacent concentrated windings are located in a single slot of the rotor core.

16. A machine as claimed in claim 1, in which the stator comprises a core that defines a plurality of open slots, in which the concentrated windings are seated.

17. A machine as claimed in claim 1, in which the concentrated windings are prefabricated.

18. A machine as claimed in claim 1, in which the stator is linear.

19. A machine as claimed in claim 1, in which the stator is more than twice as long as the rotor.

20. A machine as claimed in claim 1, in which the stator is cylindrical.

21. A machine as claimed in claim 1, in which the stator is in a shape of a disk.

22. A machine as claimed in claim 1, which is arranged to utilise power transferred in use from the primary windings to the secondary windings to power auxiliary mechanisms associated with the machine.

23. (canceled)
